(19) United States
(12) Patent Application Publication
(10) Pub. No.: US 2020/0001307 A1
(43) Pub. Date: Jan. 2, 2020

(54) Anion Air Purifier

(71) Applicant: HUI-LING CHIANG, New Taipei City (TW)

(72) Inventor: HUI-LING CHIANG, New Taipei City (TW)

(21) Appl. No.: 16/455,633

(22) Filed: Jun. 27, 2019

(30) Foreign Application Priority Data
Jun. 28, 2018 (TW) 107208744

(51) Int. Cl. B03C 3/68; B03C 3/06; B03C 3/38; B03C 3/41; B03C 3/49

(52) U.S. Cl. CPC B03C 3/68; B03C 3/06; B03C 2201/06; B03C 3/41; B03C 3/49; B03C 3/38

(57) ABSTRACT

An anion air purifier includes an air quality sensor control module, a high-voltage generator module arranged on a back side of the air quality sensor control module, and an anion generator module arranged on the back side of the high-voltage generator module. The air quality sensor control module includes a plurality of sensing elements arranged therein for sensing air qualities. The high-voltage generator module includes an anode dust arrester upwardly and protrudingly arranged at a center thereof. The anode dust arrester is a round flat hollow structure. The anion generator module includes a plurality of pins arranged thereon for releasing anion. Particles in the air binding with anion will be charged, so as to be attached on the anode dust arrester when flowing thereby and therefore leave clean air flow. Accordingly, it can effectively eliminate particles of the air, release massive clean air, and lower unnecessary ozonized ions.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a technology of anion air purifier, and particularly to an anion producing technology utilizing an electron emission design and an anode dust arrester having a round flat hollow structure, so as to attach the particles in the air to the anode dust arrester as they are passing through the anode dust arrester and allow massive clean air to pass through the anode dust arrester, that allows the anion air purifier to effectively expand the scope and speed of absorbing the particles of the air.

### Description of Related Arts

As the air quality becomes worse and worse and the air pollution turns heavier and heavier globally, there have been increasingly various types of air purifiers in the market aiming to purify the air and avoid dirty air from harming the user's body.

Particle Matter (PM) value is one of the indications for monitoring air pollution. Recently, people start to realize that particle matters can harm their bodies, so that more and more people wear breathing mask outdoors to avoid inhaling too much particle matters. Nevertheless, there are still particle matters at home, in indoor spaces, and in the confined space of a car. To deal with that, many people would like to place air purifiers at home for air purification.

Conventional anion air purifier produces anions through corona discharge means. The anions generated will bind the particles in the air, charge them, and have them fallen onto the earth. The ways to deliver the anions include diffusion and forced flowing by fan. As a result, after the particles have fallen on the ground, the flowing air can raise them back to the air very easily. Therefore, such conventional devices can barely achieve their expected function and results. Besides, anion produced through corona discharge can produce too many ozonide ions easily and unfortunately ozone is irritant to the respiratory system, that may render cough, asthma, headache, fatigue, and lung damage, causing countereffects possibly.

Hence, the way to create an anion air purifier that produces less unnecessary ozonide ion and adsorbs particle matters of the air effectively and quickly without having them be raised back to the air again, in order to effectively clean the particle matters from the air and enhance the range and speed of adsorbing particle matters from the air so as to increase the overall utility thereof, which become objects of the present invention to be disclosed.

### SUMMARY OF THE PRESENT INVENTION

An object of the present invention is to provide an anion air purifier, which is able to effectively and quickly attach and adsorb the particulate matters in the air without producing too much ozone, to expand the scope and speed of absorbing the particle matters of the air, and to enhance the air purification efficiency, so as to have an advanced overall utility.

In order to achieve the above and other objects, the present invention provides an anion air purifier, which includes an air quality sensor control module, a high-voltage generator module, and an anion generator module. The air quality sensor control module includes a plurality of sensing elements arranged therein for sensing the air qualities. The high-voltage generator module is arranged on a back side of the air quality sensor control module. The high-voltage generator module includes an anode dust arrester upwardly and protrudingly arranged at a center thereof. The anode dust arrester is a round flat hollow structure, so as for clean air to pass through quickly and massively. The anion generator module is arranged on a back side of the high-voltage generator module. The anion generator module includes a plurality of pins arranged thereon for releasing anion. Particles in the air binding with anion will be charged so as to be attached on the anode dust arrester when flowing thereby and therefore leave clean air flow.

According to a preferred embodiment, the air quality sensor control module comprises a display, a plurality of LEDs and a plurality of panel buttons, so as for displaying the air qualities, time, and all kinds of data as well as for setting up boot modes, time, time announcement, and air quality standards. The anode dust arrester can be directly removed from the surface of the high-voltage generator module to be washed and cleaned, such that it does not require frequent replacement of the dust arrest consumables, which is more environmental friendly.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an anion air purifier according to a preferred embodiment of the present invention.

FIG. 2 is a side perspective view of the anion air purifier according to the above preferred embodiment of the present invention.

FIG. 3 is a perspective view illustrating the air flow of the anion air purifier according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

The following is disclosed with specific embodiments to illustrate implementations of the present invention in order that person skilled in the art can understand the functions and other advantages of the present invention easily.

The appended drawings are utilized as reference to illustrate the embodiments of the present invention. However, it should be noted that the drawings are simplified perspective figures for illustrating basic concepts of the present invention only. Hence, it only demonstrates relative structures of the present invention, rather than reveals the specific quantities, shapes, and sizes of the elements of the actual implementations. It is worth mentioning that the forms, quantities, and ratios of the elements of the actual implementations of the present invention may change based on actual needs and shall not be limited by the drawings.

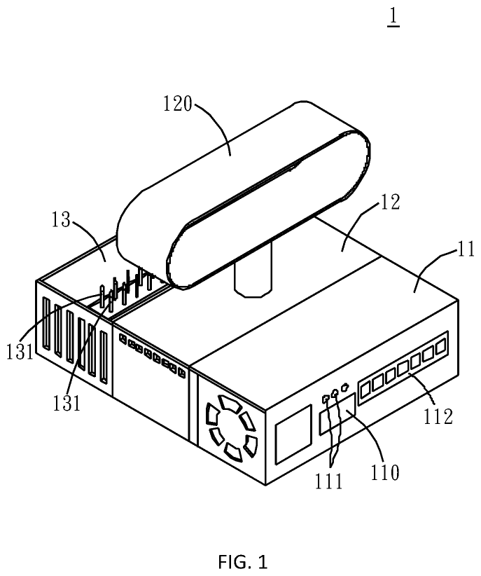

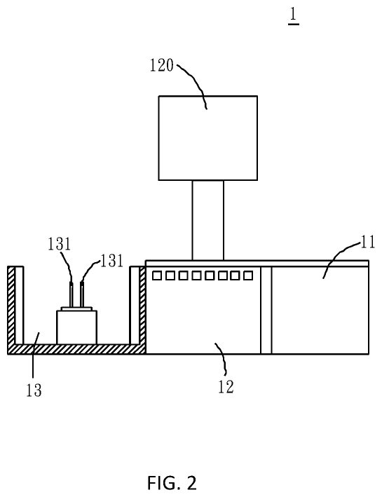

Referring to FIGS. 1 and 2, a perspective view and a side perspective view of an anion air purifier according to a preferred embodiment of the present invention are illustrated. According to the figures, the anion air purifier 1 includes an air quality sensor control module 11, a high-voltage generator module 12 and an anion generator module 13. The air quality sensor control module 11 includes a plurality of sensing elements arranged therein for sensing the air qualities. The high-voltage generator module 12 is arranged on a back side of the air quality sensor control module 11. The high-voltage generator module 12 includes an anode dust arrester 120 upwardly and protrudingly arranged at a center thereof. The anode dust arrester 120 is a round flat hollow structure, so as for clean air to pass through quickly and massively. The anion generator module 13 is arranged on a back side of the high-voltage generator module 11. The anion generator module 13 includes a plurality of pins 131 arranged thereon for releasing anion. Particles in the air binding with anion will be charged so as to be attached on the anode dust arrester 120 when flowing thereby and therefore leave clean air flow.

According to a preferred embodiment, the air quality sensor control module 11 comprises a display 110, a plurality of LEDs 111, and a plurality of panel buttons 112, so as for displaying the air qualities, time, and all kinds of data as well as for setting up boot modes, time, time announcement, and air quality standards. The LEDs 111 include a blue LED, a yellow LED, and a red LED. The blue LED indicates the operation of the anion generator module 13. The yellow LED is an alarm indication. The red LED is an indication indicating that an air quality has surpassed the given standard. Detectable air qualities of the air quality sensor control module 11 include the values of: PM 2.5, eCO2, TVOC, ozone, and formaldehyde. The anode dust arrester 120 can be directly removed from the surface of the high-voltage generator module 12 to be washed and cleaned.

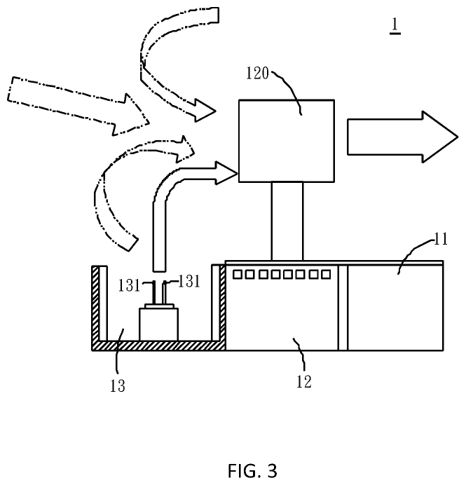

Referring to FIG. 3, a perspective view illustrating the air flow of the anion air purifier according to the preferred embodiment of the present invention is illustrated, wherein the anion air purifier 1 utilizes electron emission means to generate anions, which releases ion charges from a tip of each of the plurality of pins 131. In addition, there is an anode dust arrester 120 with a hollow structure. By the time the anion air purifier 1 is actually utilized, as the cathode releases lot of ion charges, they will be attracted by the anode dust arrester 120 when they are passing thereby (the electrons flow from the cathode to the anode), causing fast flowing anionic wind that reduces the pressure of the anion flowing area. As a result, the air pressure of the surrounding area becomes relatively large, rendering the air around there to flow into the anion flowing area, so that there will be massive air flows into the anode dust arrester 120 and the anions will bind with the particle matters in the air. Therefore, when the particle matters carrying negative charge pass through the anode dust arrester 120, they will be attracted by and attached on the surface of the anode dust arrester 120, so as to achieve the dust arresting effect. When the anode dust arrester 120 has collected a certain amount of dust, it can be directly detached from the high-voltage generator module 12 for being washed, cleaned, and dried for reusing. Hence, it does not require dust arrest consumables, which is more environmental friendly and convenient in an overall manner.

Besides, to produce anion through electron emission can produce less ozonized ions, so as to prevent ozonized ions from rendering respiratory system irritation. Furthermore, the air quality sensor control module 11 includes an ozone detector, which allows the user to set up an upper limit of ozone through the panel buttons 112. For example, when the ozone detected reaches the upper limit, it stops the anion generator from operating; when the ozone detected reaches the lower limit, it automatically resumes the operation of the anion generator, which aims to ensure that the ozone can be controlled in the given value.

In addition, it utilizes a bipolar structure and design that a cathode releases anions to bind and charge the particle matters in the air, such that the particle matters (or dusts) will be attached to the anode dust arrester 120 rather than be raised or flowed into the air again. As a result, the particle matters in the air can be actually and effectively removed.

Also, the anode dust arrester 120 has a hollow round flat structure, so as for the anion air to flow in and out easily. Accordingly, the pressure of the anion flowing area is relatively low, such that the air around there can flow into the hollow structure of the anode dust arrester 120 easily, so as to enhance the dust arresting speed and efficiency and expand the range and scope of air intake (because the hollow flat structure can utilize both inner side and outer side for particle absorption, which equals to two times of the area of the outer side thereof), such that the air can be purified quickly.

Contrasting to the conventional technology, the anion air purifier provided by the present invention is suitable for anyplace, including inside a car. The anion air purifier is not only highly efficient in dust arresting and effective in adsorbing particle matters of the air to improve the air qualities, but also capable of controlling ozonized ion production and reusable after use and clean. Therefore, it is more environmental friendly and is better in overall utility and convenience.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An anion air purifier, comprising:
an air quality sensor control module comprising a plurality of sensing elements arranged therein for sensing air qualities;
a high-voltage generator module, arranged on a back side of said air quality sensor control module, comprising an anode dust arrester upwardly and protrudingly arranged at a center thereof; and
an anion generator module, arranged on a back side of said high-voltage generator module, comprising a plurality of pins arranged thereon for releasing anion, such that particles in the air binding with anion are charged and then attached on said anode dust arrester when flowing thereby while leaving clean air flow.

2. The anion air purifier, as recited in claim 1, wherein said anode dust arrester is a round flat hollow structure, so as to allow clean air to pass through quickly and massively.

3. The anion air purifier, as recited in claim 1, wherein said air quality sensor control module further comprises a display, a plurality of LEDs and a plurality of panel buttons, adatped for setting up boot modes, time, time announcement, air quality standards and displaying the air qualities, time, and relative information.

4. The anion air purifier, as recited in claim 1, wherein said anode dust arrester is removably attached on a surface of said high-voltage generator module, so as to allow said anode dust arrester to be removed and cleaned.

5. The anion air purifier, as recited in claim 2, wherein said anode dust arrester is removably attached on a surface of said high-voltage generator module, so as to allow said anode dust arrester to be removed and cleaned.

6. The anion air purifier, as recited in claim 1, wherein said air quality sensor control module comprises an ozone detector, which allows said air quality sensor control module to stop said anion generator from operating when the ozone detected reaches a predetermined upper limit and to resume the operation of said anion generator when the ozone detected reaches a predetermined lower limit, so as to maintain the ozone within a given value.

7. The anion air purifier, as recited in claim 2, wherein said air quality sensor control module comprises an ozone detector, which allows said air quality sensor control module to stop said anion generator from operating when the ozone detected reaches a predetermined upper limit and to resume the operation of said anion generator when the ozone detected reaches a predetermined lower limit, so as to maintain the ozone within a given value.

8. The anion air purifier, as recited in claim 3, wherein said air quality sensor control module comprises an ozone detector, which allows said air quality sensor control module to stop said anion generator from operating when the ozone detected reaches a predetermined upper limit and to resume the operation of said anion generator when the ozone detected reaches a predetermined lower limit, so as to maintain the ozone within a given value.

9. The anion air purifier, as recited in claim 4, wherein said air quality sensor control module comprises an ozone detector, which allows said air quality sensor control module to stop said anion generator from operating when the ozone detected reaches a predetermined upper limit and to resume the operation of said anion generator when the ozone detected reaches a predetermined lower limit, so as to maintain the ozone within a given value.

10. The anion air purifier, as recited in claim 5, wherein said air quality sensor control module comprises an ozone detector, which allows said air quality sensor control module to stop said anion generator from operating when the ozone detected reaches a predetermined upper limit and to resume the operation of said anion generator when the ozone detected reaches a predetermined lower limit, so as to maintain the ozone within a given value.
